(19) United States
(12) Patent Application Publication
(10) Pub. No.: US 2022/0063747 A1
(43) Pub. Date: Mar. 3, 2022

(54) ROUGH TERRAIN DRIVER'S AID

(71) Applicant: Kuryakyn Holdings, LLC, Somerset, WI (US)

(72) Inventor: Anthony Donald Stefanelli, Downing, WI (US)

(21) Appl. No.: 17/009,915

(22) Filed: Sep. 2, 2020

(51) Int. Cl. B62J 27/00; B62K 11/04

(52) U.S. Cl. CPC B62J 27/00; B62K 11/04

(57) ABSTRACT

A driver's aid for a motorcycle includes a body that positions around an engine of the motorcycle. At least one slide rail has a first end hingedly coupled to the body and a cantilevered second end. A compression rod extends between the body and the slide rail.

### BACKGROUND

The disclosed embodiments are related to a motorcycle, and more particularly, to a driver's aid for operating a motorcycle in rough terrain.

Motorcycle riders occasionally want to explore a road or terrain that is not paved. The terrain may be rough or sandy, which makes it easy to tip the motorcycle onto its side. Accordingly some riders may not have the confidence to explore off-road terrains, causing the driver to avoid such terrains.

### SUMMARY

The present disclosure includes one or more of the features recited in the appended claims and/or the following features which, alone or in any combination, may comprise patentable subject matter.

According to a first aspect of the disclosed embodiments, a driver's aid for a motorcycle includes a body that positions around an engine of the motorcycle. At least one slide rail is provided. The slide rail has a first end hingedly coupled to the body and a cantilevered second end. A compression rod extends between the body and the slide rail. The slide rail is moveable between a stowed position, wherein the second end of the slide rail is positioned adjacent the engine, and a deployed position, wherein the second end of the slide rail is extended away from the engine and arranged to prevent the motorcycle from tipping over.

In some embodiments of the first aspect, the compression rod may retain the slide rail in the deployed position. The compression rod may be adjustable to adjust an angle of the slide rail in the deployed position. The angle may be adjustable between 13 degrees and 20 degrees.

Optionally, in the first aspect, the slide rail may include a first member extending between the second end and the base. A second member may extend between the base and the first member. The first member may include a first segment and a second segment extending substantially perpendicular to the first segment. The second segment may form the second end of the slide rail. A cross-beam may extend between the first member and the second member.

According to a second aspect of the disclosed embodiments, a driver's aid for a motorcycle includes a body that positions around an engine of the motorcycle. At least one slide rail is provided. The slide rail has a first end hingedly coupled to the body and a cantilevered second end. A compression rod extends between the body and the slide rail. The slide rail is moveable between a stowed position, wherein the slide rail is positioned at a first angle relative to the body, and a deployed position, wherein the slide rail is positioned at a second angle relative to the body and arranged to prevent the motorcycle from tipping over.

In some embodiments of the second aspect, the compression rod may retain the slide rail in the deployed position. The compression rod may be adjustable to adjust the second angle in the deployed position. The second angle may be adjustable between 13 degrees and 20 degrees.

Optionally, in the second aspect, the slide rail may include a first member extending between the second end and the base. A second member may extend between the base and the first member. The first member may include a first segment and a second segment extending substantially perpendicular to the first segment. The second segment may form the second end of the slide rail. A cross-beam may extend between the first member and the second member.

According to a third aspect of the disclosed embodiments, a motorcycle includes an engine. A driver's aid has a body that positions around the engine. The driver's aid includes at least one slide rail. The slide rail has a first end hingedly coupled to the body and a cantilevered second end. A compression rod extends between the body and the slide rail. The slide rail is moveable between a stowed position, wherein the slide rail is positioned at a first angle relative to the body so that the second end of the slide rail is positioned adjacent the engine, and a deployed position, wherein the slide rail is positioned at a second angle relative to the body so that the second end of the slide rail is extended away from the engine and arranged to prevent the motorcycle from tipping over.

In some embodiments of the third aspect, the compression rod may retain the slide rail in the deployed position. The slide rail may include a first member extending between the second end and the base. A second member may extend between the base and the first member. The first member may include a first segment and a second segment extending substantially perpendicular to the first segment. The second segment may form the second end of the slide rail. A cross-beam may extend between the first member and the second member. The compression rod may be adjustable to adjust the second angle in the deployed position.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a perspective view of a driver's aid positioned in a stowed position;

FIG. 2 is a perspective view of the driver's aid positioned in a deployed position;

FIG. 3 is a perspective view of the driver's aid positioned in the stowed position on a motorcycle;

FIG. 4 is a perspective view of the driver's aid positioned in the deployed position on a motorcycle;

FIG. 5 is a front view of a motorcycle having the driver's aid attached thereto in the deployed position; and

FIG. 6 is a perspective view of an adjustable compression rod formed in accordance with an embodiment.

### DETAILED DESCRIPTION

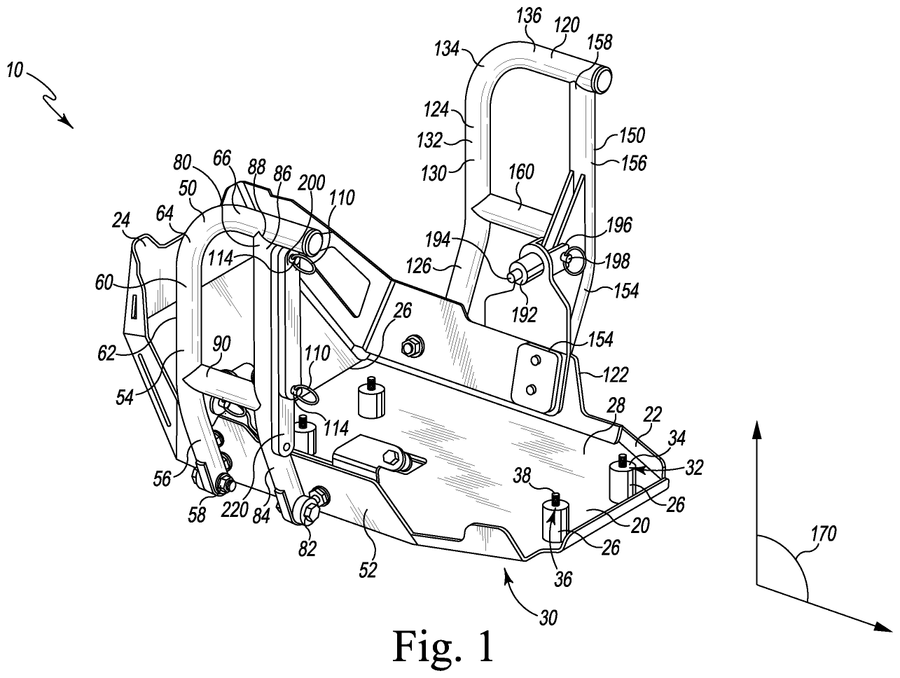

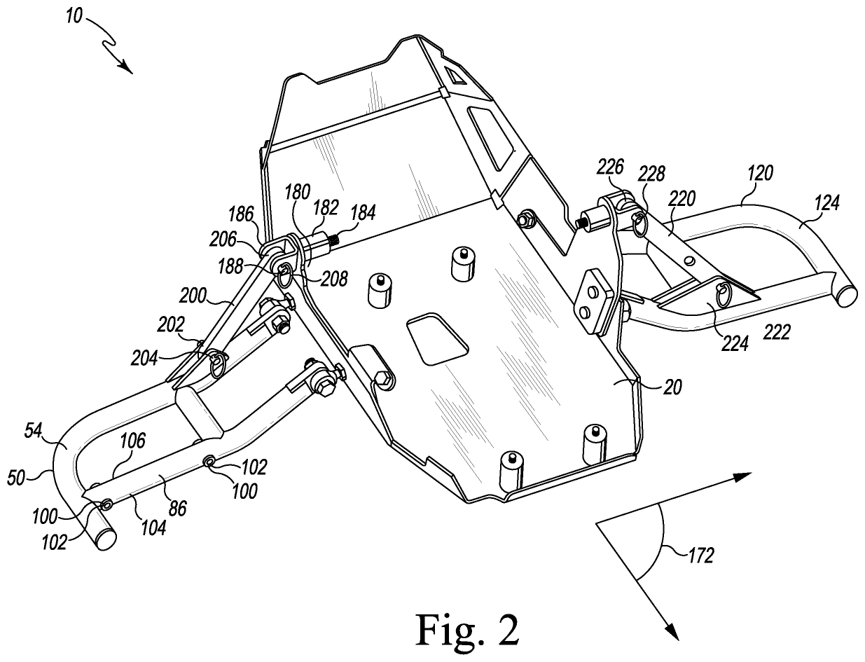

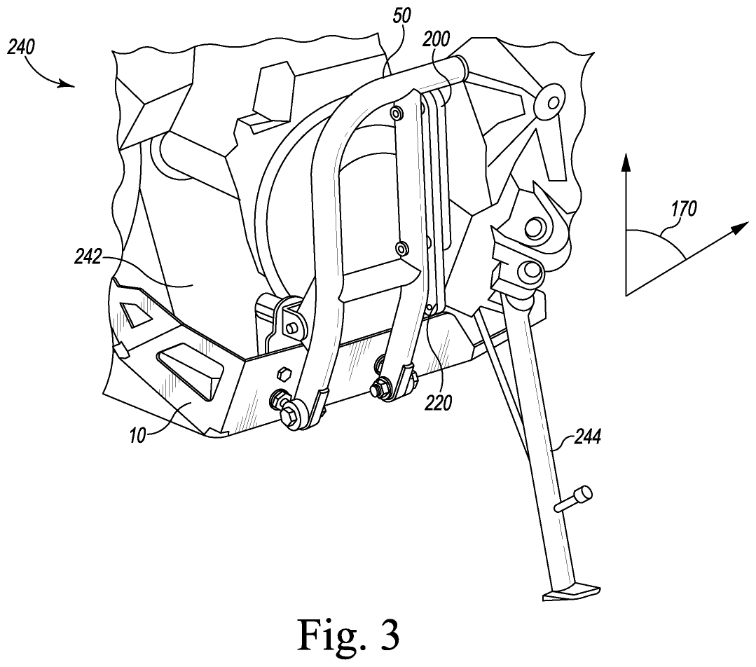

The disclosed driver's aid device 10 has two states of operation, stowed (shown in FIGS. 1 and 3), and deployed (shown in FIGS. 2, 4, and 5). In the stowed position, the device 10 offers damage protection to the motorcycle engine in the event of a tip over of the motorcycle. The driver's aid is held in the stowed position by a compression rod. If the motorcycle is tipped over, the device 10 will contact the ground prior to any other part of the motorcycle.

The device 10 hinges to the deployed position and is held in position by the compression rod. When deployed, the device 10 limits how far the motorcycle can tip over, for example, between 13 degrees and 20 degrees. The compression rod is adjustable to make the deployed position adjustable. A slide rail is intended to contact the ground when the motorcycle tips over. The rider has three ways to utilize the device 10 while deployed. First, if the motorcycle tips onto the slide rail, the rider can coast or brake to a stop. Second, if the motorcycle tips onto the slide rail, the rider can upright the motorcycle while still moving. Lastly, the rider can purposefully tip the motorcycle onto the slide rail and have three points of contact, two tires (not shown) and the slide rail, instead of just the tires. The rider can still ride the motorcycle in this state.

Referring to FIG. 1, the device 10 includes a base 20 that is configured and sized and shaped to fit over an engine (not shown) of a motorcycle (not shown). The device 10 secures to a bottom side of the engine. The base 20 includes bottom panel 22 and a front panel 24 that angles upward from a front end 26 of the bottom panel 22. In the illustrative embodiment, the front panel 24 extends at a non-orthogonal angle relative to the bottom panel 22. In some embodiments, the front panel 24 may extend at an orthogonal angle, e.g. perpendicular, from the bottom panel 22. The bottom panel 22 is configured to position under a bottom side of the engine. The front panel 24 is configured to extend along a front end of the engine.

The bottom panel 22 includes a plurality of mounts 26 extending from a top side 28 of the bottom panel 22. The mounts 26 are configured to align with a plurality of bores in the engine. Each mount 26 includes a bottom opening (not shown) formed in a bottom side 30 of the bottom panel 22 and a top opening 32 formed in a top 34 of the mount 26. A bore 36 extends from the bottom opening to the top opening 32. The bore 36 is configured to receive a fastener 38, e.g. a bolt, that is received in the bores of the engine to secure the base 20 to the bottom side of the engine.

A left slide rail 50 is coupled to a left side 52 of the base 20. That is, the left side rail 50 is coupled to the bottom panel 22. The left side rail 50 includes a curved member 54 that includes a base segment 56 that is attached to the bottom panel 22 at a hinge 58. The hinge 58 enables the left slide rail 50 to rotate relative to the base 20. An extension segment 60 extends outwardly from the base segment 56 at a non-orthogonal angle. The extension segment 60 includes a straight member 62 that extends from the base segment 56 to a curved member 64. Another straight member 66 extends from the curved member 64 substantially perpendicular to the straight member 62. The straight member 66 is configured to provide a contact point with the ground when the motorcycle tips.

A curved member 80 is attached to the bottom panel 22 at a hinge 82. The hinge 82 enables the left slide rail 50 to rotate relative to the base 20. The curved member 80 includes a base segment 84 that extends from the base 20. The base segment 84 extends substantially parallel to the base segment 56 of the curved member 54. An extension segment 86 extends from the base segment 84 at a non-orthogonal angle. The extension segment 86 extends substantially parallel to the straight member 62 of the extension segment 60 of the curved member 54. An end 88 of the extension segment 86 is coupled to the straight member 66 of the curved member 54. A cross-beam 90 extends between the extension segment 86 and the extension segment 60.

Referring to FIG. 2, the extension segment 86 includes a pair of apertures 100. The apertures 100 extend between an opening 102 on a back side 104 of the extension segment 86 and an opening (not shown) on a front side 106 of the extension segment 86. Referring back to FIG. 1, the apertures 100 are configured to receive a pin 110. Compression rods 200 and 220 secured to the extension segment 86 in FIG. 1. The compression rod 220 is longer than the compression rod 200. The compression rods 200 and 220 includes a pair of apertures 114 that are configured to receive the pins 110. As illustrated in FIG. 1, the pins 110 are extended through the apertures 114 and the apertures 100 to retain the compression rods 200 and 220 on the extension segment 86.

Referring to FIG. 2, a flange 180 extends from the base 20. The flange 180 includes a mount 182 that is configured to receive a fastener 184 to secure the flange 180 to the engine. A bracket 186 extends from the flange 180. The bracket 186 is configured to receive a pin 188 to secure the left slide rail 50 to the bracket 186 when in the position illustrated in FIG. 1.

Referring back to FIG. 1, a right slide rail 120 is coupled to a right side 122 of the base 20. That is, the right side rail 120 is coupled to the bottom panel 22. The right side rail 120 includes a curved member 124 that includes a base segment 126 that is attached to the bottom panel 22 at a hinge (not shown) that enables the right slide rail 120 to rotate relative to the base 20. An extension segment 130 extends outwardly from the base segment 126 at a non-orthogonal angle. The extension segment 130 includes a straight member 132 that extends from the base segment 126 to a curved member 134. Another straight member 136 extends from the curved member 134 substantially perpendicular to the straight member 132. The straight member 136 is configured to provide a contact point with the ground when the motorcycle tips.

A curved member 150 is attached to the bottom panel 22 at a hinge (not shown) that enables the right slide rail 120 to rotate relative to the base 20. The curved member 150 includes a base segment 154 that extends from the base 20. The base segment 154 extends substantially parallel to the base segment 126 of the curved member 124. An extension segment 156 extends from the base segment 154 at a non-orthogonal angle. The extension segment 156 extends substantially parallel to the straight member 132 of the extension segment 130 of the curved member 124. An end 158 of the extension segment 156 is coupled to the straight member 136 of the curved member 124. A cross-beam 160 extends between the extension segment 130 and the extension segment 156.

A flange 190 extends from the base 20. The flange 190 includes a mount 192 that is configured to receive a fastener 194 to secure the flange 190 to the engine. A bracket 196 extends from the flange 190. The bracket 196 is configured to receive a pin 198 to secure the right slide rail 120 to the bracket 196 when in the position illustrated in FIG. 1.

FIG. 1 illustrates the slide rails 50 and 120 in a stowed position. In the stowed position, the slide rails 50 and 120 extend upward from the base 20 at an angle 170. At the angle 170, the straight member 62 of the extension segment 60 and the extension segment 86 extend substantially perpendicular to the base 20, in some embodiments. At the angle 170, the straight member 132 of the extension segment 130 and the extension segment 156 extend substantially perpendicular to the base 20, in some embodiments. In the stowed position, the left slide rail 50 is secured to the bracket 184 with the pin 186 and the right slide rail 120 is secured to the bracket 194 with the pin 196, in some embodiments. In the stowed position, the compression rods 200 and 220 are secured to the left slide rail 50 as shown in FIG. 1, in some embodiments.

FIG. 2 illustrates the slide rails 50 and 120 in a deployed position. In the deployed position, the slide rails 50 and 120 are angled outward from the base 20 at an angle 172. At the angle 172, the straight member 62 of the extension segment 60 and the extension segment 86 extend non-orthogonally to the base 20. At the angle 172, the straight member 132 of the extension segment 130 and the extension segment 156 extend non-orthogonally to the base 20.

On the left slide rail 50, the compression rod 200 extends between the curved member 54 and the base 20. A first end 202 of the compression rod 200 is secured to the curved member 54 by a joint 204. A second end 206 of the compression rod 200 is secured to the base 20 at a joint 208. After the left slide rail 50 is rotated from the stowed position to the deployed position, the compression rod 200 is secured to the joint 208 and the joint 204. The compression rod 200 is configured to act against forces on the left slide rail 50 to hold the left slide rail 50 at the angle 172, in the deployed position. In some embodiments, the compression rod 200 is enabled to rotate about the joints 208 and 204. Accordingly, rather than stowing the compression rod 200 as illustrated in FIG. 1, the compression rod 200 rotates to the stowed position and acts against forces on the left slide rail 50 to hold the left slide rail 50 at the angle 170. That is, regardless of the position of the left slide rail 50, the compression rod 200 holds the left slide rail 50 in place.

On the right slide rail 120, the compression rod 220 extends between the curved member 124 and the base 20. A first end 222 of the compression rod 220 is secure to the curved member 124 by a joint 224. A second end 226 of the compression rod 220 is secured to the base 20 at a joint 228. After the right slide rail 120 is rotated from the stowed position to the deployed position, the compression rod 220 is secured to the joint 228 and the joint 224. The compression rod 220 is configured to act against forces on the right slide rail 120 to hold the right slide rail 120 at the angle 172, in the deployed position. In some embodiments, the compression rod 220 is enabled to rotate about the joints 228 and 224. Accordingly, rather than stowing the compression rod 220 as illustrated in FIG. 1, the compression rod 220 rotates to the stowed position and acts against forces on the right slide rail 120 to hold the right slide rail 120 at the angle 170. That is, regardless of the position of the right slide rail 120, the compression rod 200 holds the right slide rail 120 in place.

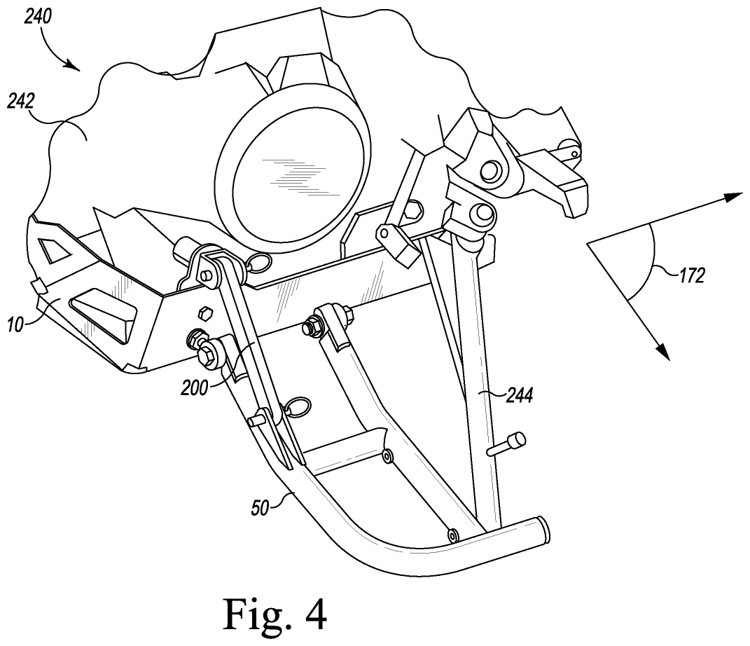

Referring to FIGS. 3 and 4, a portion of a motorcycle 240 is illustrated. In particular, an engine 242 of the motorcycle 240 is illustrated. A kickstand 244 extends from the motorcycle 240 and is shown in a deployed position, wherein the kickstand 244 is angled downward from the motorcycle 240. The kickstand 244 is illustrated to show that the left slide rail 50 has clearance from the kickstand 244 in both the stowed and deployed position. The device 10 is illustrated coupled to the motorcycle 240. The device 10 is secured around the engine 242. FIGS. 3 and 4 illustrate the left slide rail 50 and are described with respect to the left slide rail 50. However, it will be appreciated that the right slide rail 120 operates in a similar manner to the left slide rail 50.

Referring to FIG. 3, the left slide rail 50 is illustrated in the stowed position. In the stowed position, the left slide rail 50 is positioned at the angle 170. That is, the left slide rail 50 is positioned adjacent the motorcycle 240. In the stowed position, the left slide rail 50 extends upward relative to a bottom of the motorcycle 240. Further, in the stowed position, the compression rods 200 and 220 are coupled to the left slide rail 50. In the stowed position, the motorcycle 240 is operable under normal conditions. That is, the device 10 does not impede normal operation of the motorcycle 240. The base 20 of the device 10 shields the engine 242 of the motorcycle 240 from debris, e.g. rocks and sand. Likewise, the left side rail 50 provides protection from an objects that may contact the side of the engine 242.

Referring to FIG. 4, the left slide rail 50 is illustrated in the deployed position, wherein the left slide rail 50 extends away from the motorcycle 240 at the angle 172. In the deployed position, the compression rods 200 and 220 are removed and the left slide rail 50 and secured to the left slide rail 50 and right slide rail 120, respectively, as shown in FIG. 2. In the deployed position, the base 20 of the device 10 continues to provide protection to the engine 242 from debris or the like. Additionally, the left slide rail 50 provides an additional contact point with the ground during operation of the motorcycle 240. Accordingly, the motorcycle 240 has three contact points with the ground, e.g. the two tires (not shown) and the left slide rail 50. When the left slide rail 50 comes in contact with the ground, the compression rod 200 acts against forces on the left slide rail 50 to prevent the left slide rail 50 from being moved from the deployed position.

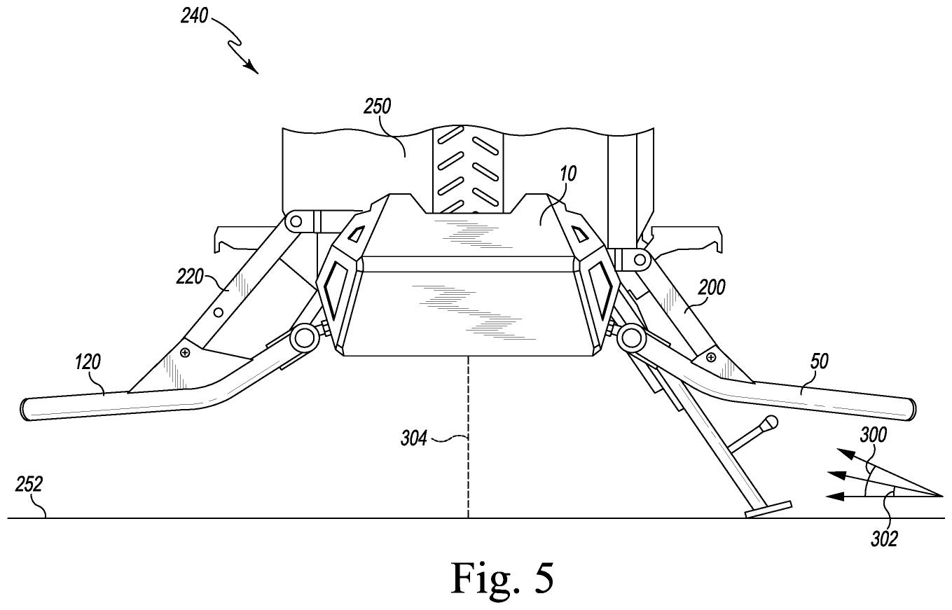

Referring now to FIG. 5, a front end 250 of the motorcycle 240 is shown. The motorcycle 240 is illustrated as being raised above the ground 252 by tires, which are not illustrated for clarity. The motorcycle 240 is illustrated with both the left slide rail 50 and the right slide rail 120 in the deployed position at the angle 172. The compression rod 200 of the left slide rail 50 and the compression rod 220 of the right slide rail 120 are adjustable, as described below, to adjust the angle 172. In FIG. 5, the slide rails 50 and 120 are illustrated at an approximately 20 degree angle 300 relative to the ground 252. That is, the straight members 66 and 136 of the left slide rail 50 and the right slide rail 120, respectively, are at a 20 degree angle relative to the ground 252. By adjusting the compression rods 200 and 220, the left slide rail 50 and the right slide rail 120, respectively, can be lowered closer to the ground to approximately a 13 degree angle 302 relative to the ground 252. Accordingly, the angle 172 may be within a range of 13 degrees to 20 degrees relative to the ground 252 or 70 degrees to 77 degrees relative to an axis 304 of the motorcycle 240, wherein the axis 304 of the motorcycle 240 is perpendicular to the ground 252. In some embodiments, the range of the angle 172 may be greater, for example, 10 degrees to 30 degrees relative to the ground 252.

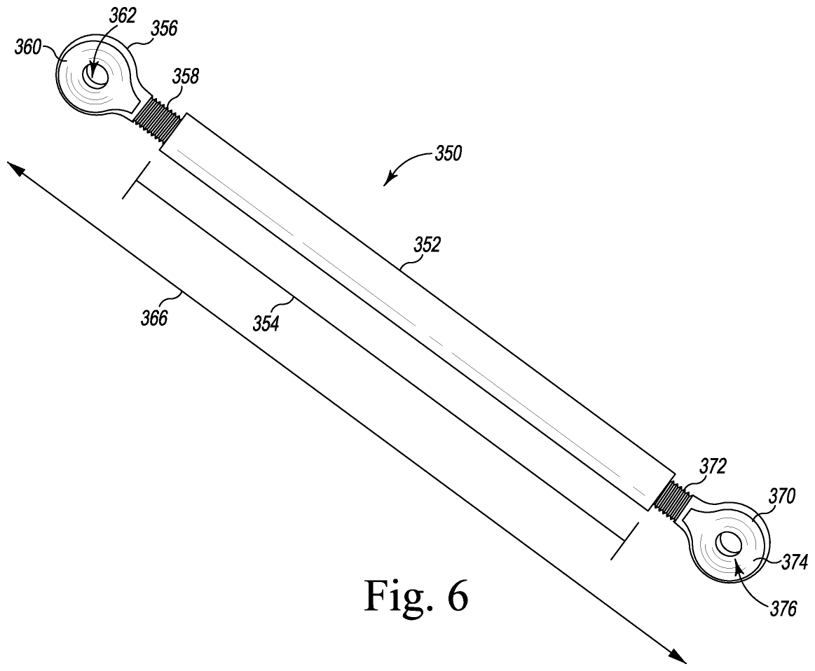

Referring now to FIG. 6, an adjustable compression rod 350 made be used in place of both compression rods 200 and 220. The compression rod 350 includes a center cylinder 352 that includes a threaded opening. The threaded opening extends an axial length 354 of the cylinder 352. An end member 356 includes a threaded end 358 that is configured to screw into the opening of the cylinder 352. A fastening end 360 includes an aperture 362 to receive a pin that secures the fastening end 360 to the joint 204. The end member 356 may be screwed into and out of the cylinder 352 to adjust a length 366 of the rod 300. By adjusting the length 366 of the rod 350, the angle 172 may be adjusted as set forth above.

Another end member 370 includes a threaded end 372 that is configured to screw into the opening of the cylinder 352. A fastening end 374 includes an aperture 376 to receive a pin that secures the fastening end 374 to the joint 208. The end member 370 may be screwed into and out of the cylinder 342 to adjust the length 366 of the rod 350. By adjusting the length 366 of the rod 350, the angle 172 may be adjusted as set forth above.

It should be noted that the end members 356 and 370 are interchangeable. That is, in some embodiments, the end member 356 may be secured to the joint 208 and the end member 370 may secured to the joint 204. Additionally, it will be appreciated that, to adjust the length 366 of the rod 350, only one of the end members 356 or 370 is required to be adjustable. In some embodiments, one of the fastening ends 360 or 374 may be fixed to the cylinder 352.

Although this disclosure refers to specific embodiments, it will be understood by those skilled in the art that various changes in form and detail may be made without departing from the subject matter set forth in the accompanying claims.

1. A driver's aid for a motorcycle comprising:
a body that positions around an engine of the motorcycle,
at least one slide rail, the slide rail having a first end hingedly coupled to the body and a cantilevered second end, and
a compression rod extending between the body and the slide rail,
wherein the slide rail is moveable between a stowed position, wherein the second end of the slide rail is positioned adjacent the engine, and a deployed position, wherein the second end of the slide rail is extended away from the engine and arranged to prevent the motorcycle from tipping over.

2. The driver's aid of claim 1, wherein the compression rod retains the slide rail in the deployed position.

3. The driver's aid of claim 1, wherein the compression rod is adjustable to adjust an angle of the slide rail in the deployed position.

4. The driver's aid of claim 3, wherein the angle is adjustable between 13 degrees and 20 degrees.

5. The driver's aid of claim 1, wherein the slide rail includes:
a first member extending between the second end and the base, and
a second member extending between the base and the first member.

6. The driver's aid of claim 5, wherein the first member includes a first segment and a second segment extending substantially perpendicular to the first segment, wherein the second segment forms the second end of the slide rail.

7. The driver's aid of claim 5, further comprising a cross-beam extending between the first member and the second member.

8. A driver's aid for a motorcycle comprising:
a body that positions around an engine of the motorcycle,
at least one slide rail, the slide rail having a first end hingedly coupled to the body and a cantilevered second end, and
a compression rod extending between the body and the slide rail,
wherein the slide rail is moveable between a stowed position, wherein the slide rail is positioned at a first angle relative to the body, and a deployed position, wherein the slide rail is positioned at a second angle relative to the body and arranged to prevent the motorcycle from tipping over.

9. The driver's aid of claim 8, wherein the compression rod retains the slide rail in the deployed position.

10. The driver's aid of claim 8, wherein the compression rod is adjustable to adjust the second angle in the deployed position.

11. The driver's aid of claim 10, wherein the second angle is adjustable between 13 degrees and 20 degrees.

12. The driver's aid of claim 8, wherein the slide rail includes:
a first member extending between the second end and the base, and
a second member extending between the base and the first member.

13. The driver's aid of claim 12, wherein the first member includes a first segment and a second segment extending substantially perpendicular to the first segment, wherein the second segment forms the second end of the slide rail.

14. The driver's aid of claim 12, further comprising a cross-beam extending between the first member and the second member.

15. A motorcycle comprising:
an engine,
a driver's aid having a body that positions around the engine, the driver's aid further comprising:
at least one slide rail, the slide rail having a first end hingedly coupled to the body and a cantilevered second end; and
a compression rod extending between the body and the slide rail,
wherein the slide rail is moveable between a stowed position, wherein the slide rail is positioned at a first angle relative to the body so that the second end of the slide rail is positioned adjacent the engine, and a deployed position, wherein the slide rail is positioned at a second angle relative to the body so that the second end of the slide rail is extended away from the engine and arranged to prevent the motorcycle from tipping over.

16. The motorcycle of claim 15, wherein the compression rod retains the slide rail in the deployed position.

17. The driver's aid of claim 15, wherein the slide rail includes:
a first member extending between the second end and the base, and
a second member extending between the base and the first member.

18. The driver's aid of claim 17, wherein the first member includes a first segment and a second segment extending substantially perpendicular to the first segment, wherein the second segment forms the second end of the slide rail.

19. The driver's aid of claim 17, further comprising a cross-beam extending between the first member and the second member.

20. The motorcycle of claim 15, wherein the compression rod is adjustable to adjust the second angle in the deployed position.
